(19) United States
(12) Patent Application Publication
(10) Pub. No.: US 2015/0309724 A1
(43) Pub. Date: Oct. 29, 2015

(54) Method and apparatus for setting keyboard

(71) Applicants: BEIJING QIHOO TECHNOLOGY COMPANY LIMITED, Beijing (CN); QIZHI SOFTWARE (BEIJING) COMPANY LIMITED, Bejing (CN)

(72) Inventor: WEI WU, BEIJING (CN)

(73) Assignee: BEIJING QIHOO TECHNOLOGY COMPANY LIMITED, Beijing (CN)

(21) Appl. No.: 14/439,093

(22) PCT Filed: Aug. 19, 2013
(86) PCT No.: PCT/CN2013/081767

§ 371 Date: Apr. 28, 2015

(30) Foreign Application Priority Data
Oct. 31, 2012 (CN) 201210430023.7

(51) Int. Cl. G06F 3/0488; G06F 3/0484; G06F 21/31; G06F 3/0482

(52) U.S. Cl. CPC G06F 3/04886; G06F 3/0482; G06F 3/04842; G06F 21/31

(57) ABSTRACT

The disclosure discloses a method and apparatus for setting a virtual keyboard which may adjust individual buttons in the virtual keyboard to prevent password cracking software from cracking a password by the approach of continuously trying to input a command sequence. The method comprises: in a current keyboard layout, receiving a character string constituted by selected button key values for password check; when it is detected that the character string matches a preset password, passing the password check of the character string; when it is detected that the character string does not match the preset password, resetting the keyboard layout, and changing the button positions corresponding to the button key values in the virtual keyboard; and in the reset keyboard layout, receiving the character string constituted by selected button key values to continue to perform the password check.

### FIELD OF THE INVENTION

The disclosure relates to the field of computer technology, and in particular, to a setting method and apparatus for processing a computer keyboard.

### BACKGROUND OF THE INVENTION

The development of science and technology has led to an increasingly wide application of terminals, for example, a computer is used for work, a tablet computer is used to watch a movie and play a game anywhere and at any time, and a mobile phone is used to communicate with others, and so on. With the development of terminal applications, the requirement for confidentiality is also higher and higher. For example, it is necessary to enter a password so that a mobile phone can be used, and it is also needed to input a password so that some important files in a terminal can be viewed.

In a terminal, a password is usually inputted by setting a virtual keyboard in a fixed area of the screen, and the positions and key values (i.e., output content) of individual buttons in the virtual keyboard are fixed. For example, the left corner of the screen is taken as an origin, the x-axis direction is towards the right, and the y-axis direction is downward. An area (10, 10, 30, 30) is a button 1, and the output content is “1”; an area (40, 10, 60, 30) is a button 2, and the output content is “2”, and the like. When a password is being inputted, it is only necessary to click areas to be able to input corresponding content, and ultimately finish inputting the password.

Therefore, there occurs some password cracking software which cracks a password taking advantage of the fixity of the keyboard. The password cracking software may obtain the position of the virtual keyboard in the screen and the positions and key values of individual buttons in the virtual keyboard, and then implement a click on an area, i.e., button in the screen by a click command, for example, successively inputting a command sequence (40, 10, 60, 30, click), (10, 10, 30, 30, click) is equivalent to inputting a character string 21. If the password is just 21, then the cracking is successful, and if the password is not 21, then the cracking fails, and the password cracking software may adjust the command sequence to continue to try to crack the password.

Generally, in a terminal, time is limited to play the role of confidentiality. For example, a failure threshold may be set for a password, and when the number of failing to input the password reaches the failure threshold, the time will be limited. For instance, a period of time will be locked for the input of a password, e.g., 5 minutes, and only after 5 minutes can one retry to input a password. However, such a limitation of time is usually for a manual input. When one person is inputting a password, many inestimable factors result in that, after trying a period of time, he might stop trying, thereby playing the role of password protection.

Yet for password cracking software, there are not inestimable factors when it is trying to crack a password. Once the password cracking software is used to crack a password, it may neglect the problem of time limitation, and continuously adjust the command sequence to try within time for which a password may be inputted, until the password cracking is successful.

Therefore, a technical problem urgent to be solved by the skilled in the art is to provide a method for setting a virtual keyboard which may adjust individual buttons in the virtual keyboard to prevent password cracking software from cracking a password by the approach of continuously trying to input a command sequence.

### SUMMARY OF THE INVENTION

In view of the above problems, the disclosure is proposed to provide a method and apparatus for setting a virtual keyboard, which overcome the above problems or at least in part solve or mitigate the above problems, and may adjust individual buttons in the virtual keyboard to prevent password cracking software from cracking a password by the approach of continuously trying to input a command sequence.

According to an aspect of the disclosure, there is provided a method for setting a virtual keyboard comprising:

in a current keyboard layout, receiving a character string constituted by selected button key values for password check;

when it is detected that the character string matches a preset password, passing the password check of the character string;

when it is detected that the character string does not match the preset password, resetting the keyboard layout, and changing the button positions corresponding to the button key values in the virtual keyboard; and

in the reset keyboard layout, receiving the character string constituted by selected button key values to continue to perform the password check.

According to another aspect of the disclosure, there is provided an apparatus for setting a virtual keyboard comprising:

a reception module configured to, in a current keyboard layout, receive a character string constituted by selected button key values for password check;

a verification passing module configured to, when it is detected that the character string matches a preset password, pass the password check of the character string;

a layout changing module configured to, when it is detected that the character string does not match the preset password, reset the keyboard layout, and change the button positions corresponding to the button key values in the virtual keyboard; and

triggering the reception module for, in the reset keyboard layout, receiving the character string constituted by selected button key values to continue to perform the password check.

According to yet another aspect of the disclosure, there is provided a computer program comprising a computer readable code which causes a server to perform the method for setting a virtual keyboard according to any of claims 1-8, when said computer readable code is running on the server.

According to still another aspect of the disclosure, there is provided a computer readable medium storing the computer program as claimed in claim 12 therein.

The beneficial effects of the disclosure lie in that:

Firstly, the disclosure may, in a current keyboard layout, receive a character string constituted by selected button key values, then when the character string does not match a preset password, reset the keyboard layout, and change the button positions corresponding to the button key values in the virtual keyboard. Then password cracking software can neither correctly obtain the button positions of the keyboard in the screen, nor correctly obtain key values of individual buttons in the keyboard. When the password cracking software tries to input a password, it may input a character string that was inputted ever, or also may not be able to input a character string, such that the password cracking software fails to crack, and that a terminal, a file in the terminal and an application in the terminal that need password protection are more secure, and the password may play its role.

Secondly, the disclosure may reserve the positions of individual buttons in the virtual keyboard and change the button key values corresponding to the positions of individual buttons, or change the positions of individual buttons in the virtual keyboard, and configure button key values for the positions of individual buttons. The approaches are flexible, and the keyboard layout may be reset rapidly by these two approaches, thereby having the effect of security protection without affecting the input of a user.

Thirdly, the disclosure further comprises a list of keyboard layouts, a list of button areas and a list of button content, and through the above lists, may rapidly obtain the list of button areas, the button positions and the button key values, and rapidly constitute a corresponding relationship between the positions of individual buttons and the button key values, thereby rapidly constituting a reset keyboard layout.

The above description is merely an overview of the technical solutions of the disclosure. In the following particular embodiments of the disclosure will be illustrated in order that the technical means of the disclosure can be more clearly understood and thus may be embodied according to the content of the specification, and that the foregoing and other objects, features and advantages of the disclosure can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the disclosure. And throughout the drawings, like reference signs are used to denote like components. In the drawings:

FIG. 1 shows schematically a flow chart of a method for setting a keyboard according to an embodiment of the disclosure;

FIG. 2 shows schematically a schematic diagram of a keyboard layout according to an embodiment of the disclosure;

FIG. 3 shows schematically a first flow chart of changing a keyboard layout in a method for setting a keyboard according to an embodiment of the disclosure;

FIG. 4 shows schematically a second flow chart of changing a keyboard layout in a method for setting a keyboard according to an embodiment of the disclosure;

FIG. 5 shows schematically a block diagram of an apparatus for setting a keyboard according to an embodiment of the disclosure;

FIG. 6 shows schematically a block diagram of a server for performing a method according to the disclosure; and

FIG. 7 shows schematically a storage unit for retaining or carrying a program code implementing a method according to the disclosure.

### DETAILED DESCRIPTION OF THE INVENTION

In the following the disclosure will be further described in connection with the drawings and the particular embodiments.

In the prior art, the layout of a virtual keyboard is fixed, namely, the areas and positions in a terminal in which a password is inputted are fixed, and therefore, password cracking software may be set to utilize the fixity of the keyboard to crack the password. After obtaining the position of the keyboard in the screen, and the positions and key values of individual buttons in the keyboard, the password cracking software may try to input a password by continuously adjusting a command sequence, until the password cracking is successful.

The disclosure provides a method for setting a keyboard, which may automatically change the layout of the keyboard, and change the button positions corresponding to the button key values in the virtual keyboard, such that password cracking software can not learn the position of the virtual keyboard in the screen and the button key values in the virtual keyboard, and thereby can not try to crack a password.

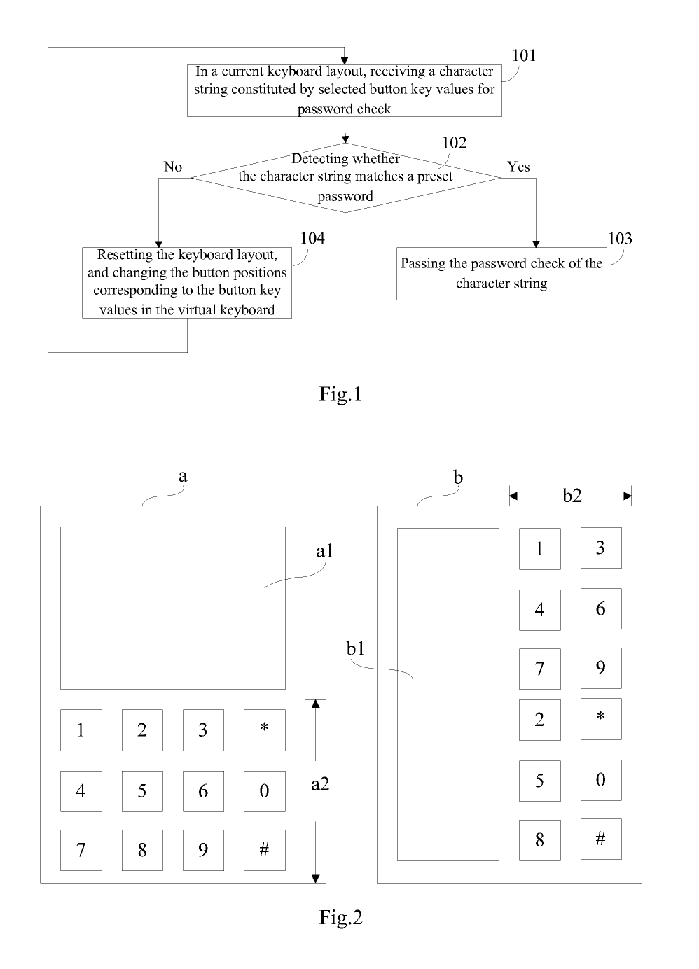

Reference is made to FIG. 1, which presents a flow chart of a method for setting a keyboard according to an embodiment of the disclosure.

Reference is made to FIG. 2, which presents a schematic diagram of a keyboard layout according to an embodiment of the disclosure.

Therein, a is a first keyboard layout, a1 is the screen part in the first keyboard layout, and a2 is the button position part in the first keyboard layout, wherein “0”, “1”, . . . , “9”, “*”, “#” represent a button position, respectively.

b is a second keyboard layout, b1 is the screen part in the second keyboard layout, and b2 is the button position part in the second keyboard layout, wherein “0”, “1”, . . . , “9”, “*”, “#” represent a button position, respectively.

In the following, the embodiment will be described particularly in connection with FIG. 2.

At step 101, in a current keyboard layout, a character string constituted by selected button key values is received, and password check is performed.

With the development of terminal applications, the requirement for confidentiality is also higher and higher. For example, it is necessary to enter a password so that a mobile phone can be used, it is also needed to input a password so that some important files in a terminal can be viewed, and it is needed to input a password so that some applications in a terminal can be used.

After a user is prompted to input a password, a password input interface will be displayed. When the user inputs a password this time, the displayed password input interface is the current keyboard layout. Assume that the first keyboard layout a is the current keyboard layout. The user may input a password under the current keyboard layout, e.g., 1234, that is, clicks the button positions “1”, “2”, “3”, “4” in the current keyboard layout, respectively, and may obtain a character string “1234” constituted by button key values.

Then, in the current keyboard layout, the character string constituted by the selected button key values is received. In FIG. 2, the button positions “1”, “2”, “3”, “4” correspond to button key values 1234, respectively, and then the character string “1234” is inputted as a password inputted this time, and afterwards, a password check process is performed.

At step 102, it is detected whether the character string matches a preset password.

The preset password may be a currently set password. For example, when entering an application 1, the preset password is a password configured for the application 1. For another example, when a mobile phone is used, the preset password is an unlocking password configured for the mobile phone. Only after the password verification is passed, an item for which a password has been set, e.g., an application, a mobile phone, etc., can be entered.

In the process of password check, it is to detect whether the character string matches the preset password, namely, verify whether the inputted password is correct or not. If the preset password is 1234, then it is matched, and if the preset password is not 1234, then it is not matched.

If yes, that is, it is detected that the character string matches the preset password, then step 103 is subsequently performed; and if no, that is, it is detected that the character string does not match the preset password, then step 104 is subsequently performed.

At step 103, the verification of the character string is passed.

If the character string matches the preset password, namely, the password input is correct, then the verification of the character string is passed, and the user performs a subsequent operation according to different application scenarios, for example, he may use a terminal; for another example, he may open and view a file, and the like.

At step 104, the keyboard layout is reset, and the button positions corresponding to the button key values in the virtual keyboard are changed.

In the disclosure, to prevent password cracking software from cracking a password by the approach of continuously trying to input a command sequence, the keyboard layout will hence be changed.

In fact, the display interface of a terminal may display individual buttons, and then when the user selects a button, the button key value of the button may be inputted, that is, there are stored the positions of the individual buttons in the button layout, there is a corresponding relationship between the positions of the individual buttons and the button key values, and a button key value may be inputted by selecting the position of the button. Therefore, when resetting the keyboard layout, the button positions corresponding to the button key values in the virtual keyboard may be changed.

For example, the positions of a1 and a2 in the first keyboard layout a in FIG. 2 are exchanged, namely, the screen part and the button position part in the first keyboard layout are upside down, constituting a reset keyboard layout. Before resetting, the button position corresponding to the button key value “1” is (10, 100, 30, 120), and after resetting, the button position corresponding to the button key value “1” is (10, 10, 30, 30).

For another example, in the first keyboard layout a in FIG. 2, the button key values of the first row and the second row in the button position part a2 are exchanged, namely, the button position originally corresponding to the button key value “1” corresponds to the button key value “4” after resetting, and so on, thereby constituting a reset keyboard layout.

In the reset keyboard layout, the character string constituted by selected button key values is received to continue to perform the password check.

After the keyboard layout is reset, the password input interface displayed in the terminal is the reset keyboard layout, that is, the reset keyboard layout is taken as the current keyboard layout, and then the process returns to step 101 to receive the character string constituted by selected button key values to continue to perform the password check. In particular, the above steps may be repeated, until the password check is passed.

After resetting the keyboard layout, the process subsequently returns to step 101, may receive a character string again, and perform password input and verification. After the keyboard layout is changed, the password cracking software can neither correctly obtain the button positions of the keyboard in the screen, nor correctly obtain key values of the buttons in the keyboard. And then when the password cracking software continuously tries to input a password, it may input a character string that was inputted ever, or also may not be able to input a character string.

To sum up, the disclosure may, in a current keyboard layout, receive a character string constituted by selected button key values, then when the character string does not match a preset password, reset the keyboard layout, and change the button positions corresponding to the button key values in the virtual keyboard. Then password cracking software can neither correctly obtain the button positions in the screen, nor correctly obtain key values of the buttons. When the password cracking software tries to input a password, it may input a character string that was inputted ever, or also may not be able to input a character string, such that the cracking by the password cracking software fails, and that a terminal, a file in the terminal and an application in the terminal that need password protection are more secure, and the password may play its role.

Optionally, after it is detected that the character string does not match the preset password, there is further comprised:

detecting whether the number of input times has reached a failure threshold, and if yes, resetting the keyboard layout, or else receiving a character string again.

If the character string does not match the preset password, it is detected whether the number of input times in the current keyboard layout has reached the failure threshold, wherein if the inputted character string matches the preset password, the character string will directly pass the verification, and the number does not need to be recorded, and therefore, the number of input times may be a number of times for which the inputted character string in the current keyboard layout does not match the preset password. The failure threshold is a maximum number of failures for inputting character strings in a keyboard layout. For example, suppose that the number of failures is 3, and then it is detected whether the number of input times has reached 3 in the current keyboard layout.

If yes, namely, the number of input times has reached the failure threshold, then it is necessary to reset the keyboard layout, for example, perform the above operation of step 104; and if no, namely, the number of input times has not reached the failure threshold, then the process continues to detect whether the number of input times for subsequently inputted character strings has reached the failure threshold.

In the prior art, if the number of input times has reached the failure threshold, the prior art will limit the time. For instance, a period of time will be locked for the input of a password, e.g., 5 minutes, and only after 5 minutes can one retry to input a password. However, if the password cracking software continues to try to input a password after the lock time, then the password will be cracked in the end.

Yet the disclosure may reset the keyboard layout after the number of input times has reached the failure threshold, such that the password cracking software can not obtain correct button key values, the password is prevented from being cracked, and the security of the terminal is protected.

Optionally, the changing the button positions corresponding to the button key values in the virtual keyboard comprises:

1) reserving the positions of individual buttons in the virtual keyboard and changing the button key values corresponding to the positions of individual buttons.

When resetting the keyboard layout, the positions of displayed individual buttons will not be changed, but the button key value corresponding to each position will be changed, that is to say, it may be that the positions of individual buttons in the virtual keyboard are reserved, but the button key values corresponding to the positions of the individual buttons are changed, so as to implement resetting of the keyboard layout.

For instance, in the above example, the button position part a2 is unchanged, and the button key values of the first row and the second row in the button position part a2 are exchanged, namely, the button position originally corresponding to the button key value “1” corresponds to the button key value “4” after resetting, and so on, thereby constituting a reset keyboard layout.

2) changing the positions of individual buttons in the virtual keyboard, and configuring button key values for the positions of individual buttons.

When resetting the keyboard layout, it may also be that the positions of displayed individual buttons in the terminal are changed, and then corresponding button key values are configured for the individual positions, namely, the positions of the individual buttons are changed, and an unique button key value is configured for each of the button positions.

For instance, in the above example, the positions of a1 and a2 in the first keyboard layout a in FIG. 2 are exchanged, constituting a reset keyboard layout. Before resetting, the button position corresponding to the button key value “1” is (10, 100, 30, 120), and after resetting, the button position corresponding to the button key value “1” is (10, 10, 30, 30).

Therefore, if the approach described in 1) is adopted, the button positions in the reset keyboard layout are unchanged, but the button key values corresponding to the positions of the individual buttons are changed. Therefore, after the password cracking software selects button positions, the button key values intended to be inputted and the actually inputted button key value will differ. For instance, in the example in 1), the password cracking software selects a button position (10, 100, 30, 120) to intend to input the button key value “1”, but the actual button key value is “4”.

Yet if the approach described in 2) is adopted, the positions of individual buttons have been changed in the reset keyboard layout, and thus the problem that inputting can not be done may occur when the password cracking software is selecting a button position. For instance, in the example in 2), when the password cracking software selects the button position (10, 100, 30, 120) to intend to input the button key value “1”, a button key value can not be inputted since a button is not present on the coordinate (10, 100, 30, 120) in the keyboard layout at this point.

Of course, for the approach described in 2), a case may also occur that after the password cracking software selects a button position, the button key value intended to be inputted and the actually inputted button key value differ, and these are not listed here one by one, which should not be understood to be limiting to the disclosure.

To sum up, the disclosure may reserve the positions of individual buttons in the virtual keyboard and change the button key values corresponding to the positions of individual buttons, or change the positions of individual buttons in the virtual keyboard, and configure button key values for the positions of individual buttons. The approaches are flexible, and the keyboard layout may be reset rapidly by these two approaches, thereby having the effect of security protection without affecting the input of a user.

Optionally, the positions of the individual buttons in the keyboard layout are saved in a list of button areas; individual lists of button areas are saved in a set of lists of button areas; the button key values are saved in a list of button content; and a corresponding relationship between individual button positions in a selected list of button areas and button key values is saved in a list of button layouts.

In order to more rapidly change the keyboard layout, the disclosure may preset a list of button areas, the list of button areas is configured to save the positions of the individual buttons in the keyboard layout, i.e., save the positions of buttons displayed in the screen. Each of the button positions corresponds to a position in the screen, and then all the button positions in the screen may constitute a list of button areas. For example, a and b in FIG. 2 are constituted by two different lists of button areas, and assume that what is displayed by a is the button positions in a first list of button areas, and what is displayed by b is the button positions in a second list of button areas. For another example, what is displayed by a in FIG. 2 is the button positions in a first list of button areas, and if a button position is arbitrarily selected therefrom, and the selected button position is changed to other position in the screen with other button positions unchanged, then a new list of button areas may be constituted.

Then a certain list of button areas is selected. Ibid, a in FIG. 2 is the current keyboard layout, what is selected by the current keyboard layout is the first list of button areas, and therefore if it is to change a button position(s), another list of button areas may be selected, which differs from the list of button areas selected by the current keyboard layout, for example, a second list of button areas selected by b in FIG. 2 is chosen.

Then, a button position is obtained randomly in the selected list of button areas, then a button key value corresponding to the button position may be selected, and the button position and the corresponding button key value are saved together.

Therein, when a button position is changed, the order of button key values corresponding to the button positions in the current keyboard layout may be pre-recorded, and then after the button position is selected, a button key value may be configured for the button position still according to the order. For example, the button positions in a list of button areas are upside down with respect to the button positions as shown by a in FIG. 2, and if this list of button areas is selected, then if button key values are configured for the button positions according to the order, the effect displayed in the screen may be that a1 and a2 are exchanged.

The list of button areas for saving the positions of the buttons displayed in the screen may be in the form as shown in table 1:

TABLE 1

| Number of button position | Position in the screen |
|---|---|
| y1 | (10, 100, 30, 120) |
| y2 | (40, 100, 60, 120) |
| . . . | . . . |

Table 1 is just one form of the list of button areas, and in a particular implementation, it may further comprise other forms, and should not be understood as limiting to the disclosure.

Therein, a position in the screen may be a coordinate position in the screen, for example, the left corner is taken as the origin, the positive x-axis is to the right and the positive y-axis is downwards.

In the actual processing, numbers of individual button positions in the list of button areas may be differentiated in advance, for example, numbering is done according to an order of from left to right and from top to bottom.

For example, in the list of button areas, the button position corresponding to the button key value “1” displayed by a in FIG. 2 is y1, the button position corresponding to the button key value “*” is y4, the button position corresponding to the button key value “4” is y5, and so on. For another example, the button position corresponding to the button key value “1” displayed by b is y1, the button position corresponding to the button key value “*” is 12, the button position corresponding to the button key value “4” is y3, and so on.

Then, numbers of individual button positions may be recorded in the list of button areas, and then a list of button areas may be uniquely constituted by all the button positions. Therefore, after a list of button areas is selected, a button key value may be configured for each numbered button position, namely, an output value (i.e., a button key value) is configured for a coordinate position in the terminal.

If it is to reserve the positions of individual buttons in the virtual keyboard and change the button key values corresponding to the button positions, then the list of button areas in the current keyboard layout may be reserved, whereas for each of the button positions, a button key value is obtained randomly, and a corresponding relationship between the button position and the button key value is established, i.e., the button key value is configured for the button position.

For example, the selected list of button areas is unchanged, e.g., still the list of button areas selected by a in FIG. 2, then a button key value may be obtained randomly for the button position corresponding to the original button key value “1”, and at this point, the probability of obtaining the same button key value as before (i.e., the button key value corresponding to the button position in the current keyboard layout before the change) is 1/12, i.e., the probability of being identical is low, and moreover, the probability of all the button positions being identical to the previous button key values is 1/(12*12), i.e., the probability is very low and it may be considered not to happen. Of course, if the button positions in the keyboard are more, then the probability is lower. At this point, in order to still further ensure that the button positions and the previous button key values will not coincide, the button key values corresponding to the button positions in the current keyboard layout before the change may further be pre-recorded. Then after a button key value is obtained randomly, it is compared with the recorded content, and if they are different, a corresponding relationship between the button positions and the button key values may be established, and if they are identical, then re-selection may be done.

The disclosure may further comprise a list of keyboard layouts comprising button positions in a keyboard layout to be displayed and corresponding button key values. In the list of keyboard layouts is saved a corresponding relationship between individual button positions in a selected list of button areas and button key values, which is as shown in table 2:

TABLE 2
First list of button areas

| Button position | Button key value |
|---|---|
| y1 | 1 |
| . . . | . . . |

Table 2 is just one form of the list of keyboard layouts, and in a particular implementation, it may further comprise other forms, and should not be understood as limiting to the disclosure.

In the actual processing, in the list of keyboard layouts there may be comprised a selected list of button areas, and saved a corresponding relationship between the button positions corresponding to individual numbers in the selected list of button areas and button key values.

For example, the button position corresponding to the button key value “1” displayed by a in FIG. 2 is y1, the button position corresponding to the button key value “*” is y4, the button position corresponding to the button key value “4” is y5, and so on. For another example, the button position corresponding to the button key value “1” displayed by b is y1, the button position corresponding to the button key value “*” is 12, the button position corresponding to the button key value “4” is y3, and so on.

The list of button areas is configured to save the positions of the buttons displayed in the screen, and therefore, a different position of the button positions in the screen corresponds to a different list of button areas. In the disclosure there are comprised multiple lists of button areas, and therefore, all the lists of button areas may constitute a set of lists of button areas, and when the keyboard layout is changed, a list of button area may be selected from the set of lists of button areas.

In the disclosure there may be further comprised a list of button content comprising button key values and the display content of the buttons as shown in table 3:

TABLE 3

| Button key value | Display content of button |
|---|---|
| 1 | 1 |
| * | * |
| . . . | . . . |

Table 3 is just one form of the list of button content, and in a particular implementation, it may further comprise other forms, and should not be understood as limiting to the disclosure.

Optionally, in the list of button content there is further comprised the display content of the buttons, and there is a one-to-one correspondence between the display content of the buttons and the button key values.

In the keyboard layout, each button position corresponds to the display content of the button, and the button key value of the button position may be learned by the display content, e.g., “1”, “2”, etc. displayed in the button position part in FIG. 2. The display content of the buttons is identical to the button key values, for example, the button key value corresponding to the button position where “1” is displayed in FIG. 2 is 1. Of course, a case may also occur that the display content of the buttons is not identical to the button key values, which will not be defined by the disclosure.

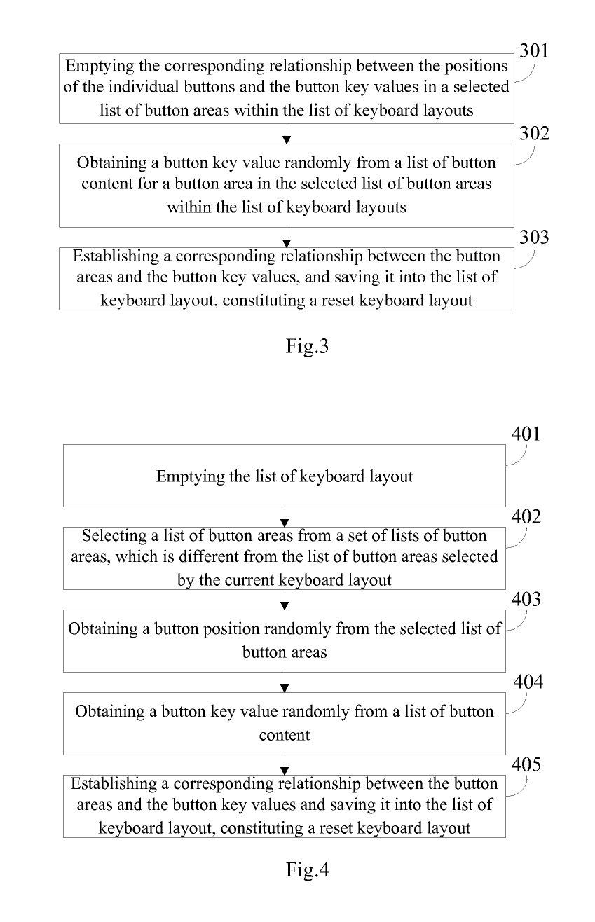

Reference is made to FIG. 3, which presents a first flow chart of changing a keyboard layout in a method for setting a keyboard according to a preferred embodiment of the disclosure.

Optionally, the reserving the positions of individual buttons in the virtual keyboard and changing the button key values corresponding to the positions of individual buttons comprises the following steps.

At step 301, the corresponding relationship between the positions of the individual buttons and the button key values in a selected list of button areas within the list of keyboard layouts is emptied.

If it is to reserve the positions of individual buttons in the virtual keyboard and change the button key values corresponding to the positions of individual buttons, namely, change the button key values corresponding to the button positions, the selected list of button areas may not be changed, and therefore the corresponding relationship between the individual button areas and the button key values in the selected list of button areas within the list of keyboard layouts may be emptied.

At this point, in the list of keyboard layouts there may be comprised a list of button areas and the positions of individual buttons in the list of button areas.

At step 302, a button key value is obtained randomly from a list of button content for a button area in the selected list of button areas within the list of keyboard layouts. Then, a button key value is obtained randomly from a list of button content for a button area in the selected list of button areas within the list of keyboard layouts. Since the number of button areas is large, when obtaining a button key value randomly, the probability of the constituted keyboard layout and the current keyboard layout being exactly the same is very low, namely, the probability of all the button areas being identical to the previous button key values is very low.

At this point, in order to still further ensure that the button areas and the previous button key values will not coincide, the button key values corresponding to the button areas in the current keyboard layout before the change may further be pre-recorded. Then after a button key value is obtained randomly, it is compared with the recorded content, and if they are different, a corresponding relationship between the button areas and the button key values may be established, and if they are identical, then re-selection may be done.

At step 303, a corresponding relationship between the button areas and the button key values is established, and saved into the list of keyboard layout, constituting a reset keyboard layout.

Then, a corresponding relationship between the button areas and the button key values is established, namely, a corresponding button key value is configured for each of the button areas, and then the corresponding relationship is saved into the list of keyboard layout, constituting a reset keyboard layout.

Reference is made to FIG. 4, which presents a second flow chart of changing a keyboard layout in a method for setting a keyboard according to a preferred embodiment of the disclosure.

Optionally, the changing the positions of individual buttons in the virtual keyboard, and configuring button key values for the positions of individual buttons comprises the following steps.

At step 401, the list of keyboard layout is emptied.

If it is to change the positions of individual buttons in the virtual keyboard, then the list of keyboard layout may be emptied, namely, in the list of keyboard layout, there is not recorded the selected list of button areas, and there is no a corresponding relationship between the positions of individual buttons and the button key values, either.

At step 402, a list of button areas is selected from a set of lists of button areas, which is different from the list of button areas selected by the current keyboard layout.

Then, a list of button areas is selected from a set of lists of button areas, which is different from the list of button areas selected by the current keyboard layout. For example, the list of button areas selected by the current keyboard layout is the first list of button areas, and then at this point any list of button areas other than the first list of button areas may be selected, e.g., the second list of button areas.

At step 403, a button position is obtained randomly from the selected list of button areas.

Then, a button position may be obtained randomly from the selected list of button areas, for example, the second list of button areas is selected, and a button position is obtained randomly from the second list of button areas, e.g., the No. of the selected button position is y2.

At step 404, a button key value is obtained randomly from a list of button content.

Since the positions of individual buttons have changed at the moment, it is further to configure a button key value for each of the button positions. Therefore, after selecting a list of button areas and a button position in the selected list of button areas, a button key value may be obtained randomly from a list of button content.

In order to still further ensure that the button positions and the previous button key values will not coincide, also the button key values corresponding to the button positions in the current keyboard layout before the change may be pre-recorded. Then after a button key value is obtained randomly, it is compared with the recorded content, and if they are different, a corresponding relationship between the button positions and the button key values may be established, and if they are identical, then re-selection may be done.

At step 405, a corresponding relationship between the button positions and the button key values is established and saved into the list of keyboard layout, constituting a reset keyboard layout.

To sum up, the disclosure further comprises a list of keyboard layouts, a list of button areas and a list of button content, and through the above lists, may rapidly obtain the list of button areas, the button positions and the button key values, and rapidly constitute a corresponding relationship between the positions of individual buttons and the button key values, thereby rapidly constituting a reset keyboard layout.

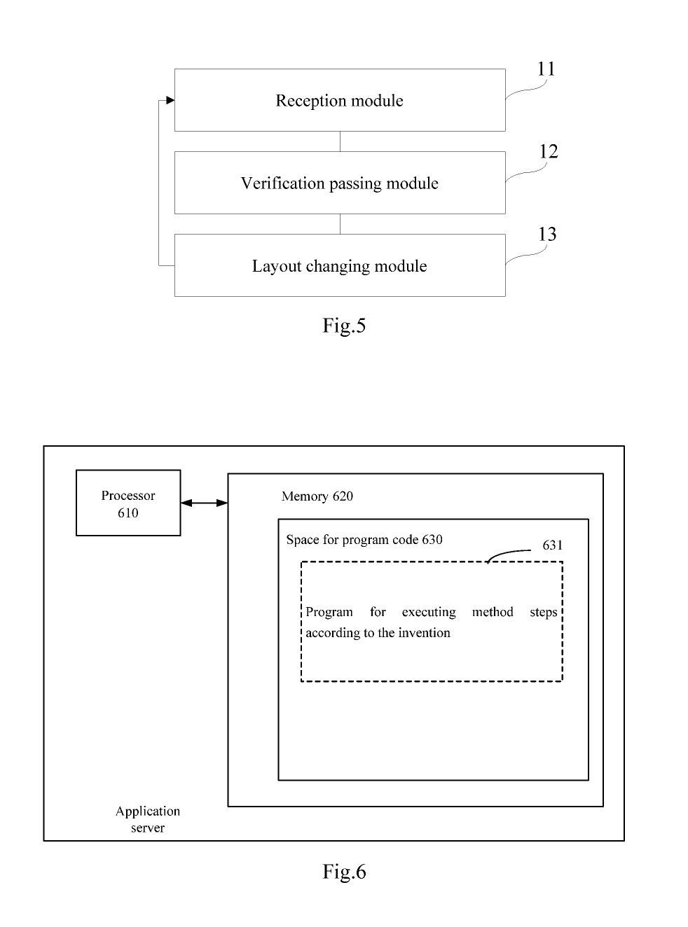

Reference is made to FIG. 5, which presents a structural diagram of an apparatus for setting a keyboard according to an embodiment of the disclosure;

Correspondingly, the disclosure further provides an apparatus for setting a keyboard comprising: a reception module 11, a verification passing module 12 and a layout changing module 13, wherein:

the reception module 11 is configured to, in a current keyboard layout, receive a character string constituted by selected button key values for password check;

the verification passing module 12 is configured to, when it is detected that the character string matches a preset password, pass the password check of the character string;

the layout changing module 13 is configured to, when it is detected that the character string does not match the preset password, reset the keyboard layout, and change the button positions corresponding to the button key values in the virtual keyboard; and

thereafter, the reception module 11 will be triggered for receiving the character string constituted by selected button key values again to continue to perform the password check.

Optionally, the layout changing module 13 comprises:

a first changing sub-module 131 configured to reserve the positions of individual buttons in the virtual keyboard and change the button key values corresponding to the positions of individual buttons.

Optionally, the layout changing module 13 comprises:

a second changing sub-module 132 configured to change the positions of individual buttons in the virtual keyboard, and configure button key values for the positions of individual buttons.

Optionally, the positions of the individual buttons in the keyboard layout are saved in a list of button areas; individual lists of button areas are saved in a set of lists of button areas; the button key values are saved in a list of button content; and a corresponding relationship between individual button positions and button key values in a selected list of button areas is saved in a list of button layouts.

Optionally, the first changing sub-module 131 comprises:

an emptying module configured to empty the corresponding relationship between the positions of the individual buttons and the button key values in a selected list of button areas within the list of keyboard layouts;

a key value selection module configured to obtain a button key value randomly from a list of button content for a button area in the selected list of button areas within the list of keyboard layouts; and

a saving module configured to establish a corresponding relationship between the button areas and the button key values, and save it into the list of keyboard layout, constitute a reset keyboard layout.

Optionally, the second changing sub-module comprises:

an emptying module configured to empty the list of keyboard layout;

a class selection module configured to select a list of button areas from a set of lists of button areas, which is different from the list of button areas selected by the current keyboard layout;

an area selection module configured to obtain a button position randomly from the selected list of button areas;

a key value selection module configured to obtain a button key value randomly from a list of button content; and

a saving module configured to establish a corresponding relationship between the button positions and the button key values and save it into the list of keyboard layout, constitute a reset keyboard layout.

Optionally, in the list of button content there is further comprised the display content of the buttons, and there is a one-to-one correspondence between the display content of the buttons and the button key values.

Optionally, the layout changing module 13 is further configured to detect whether the number of input times has reached a threshold, and if yes, reset the keyboard layout, or else receive a character string again; wherein the number of input times is a number of times for which the inputted character string in the current keyboard layout does not match the preset password.

Embodiments of the individual components of the disclosure may be implemented in hardware, or in a software module running on one or more processors, or in a combination thereof. It will be appreciated by those skilled in the art that, in practice, some or all of the functions of some or all of the components in an apparatus for setting a virtual keyboard according to individual embodiments of the disclosure may be realized using a microprocessor or a digital signal processor (DSP). The disclosure may also be implemented as a device or apparatus program (e.g., a computer program and a computer program product) for carrying out a part or all of the method as described herein. Such a program implementing the disclosure may be stored on a computer readable medium, or may be in the form of one or more signals. Such a signal may be obtained by downloading it from an Internet website, or provided on a carrier signal, or provided in any other form.

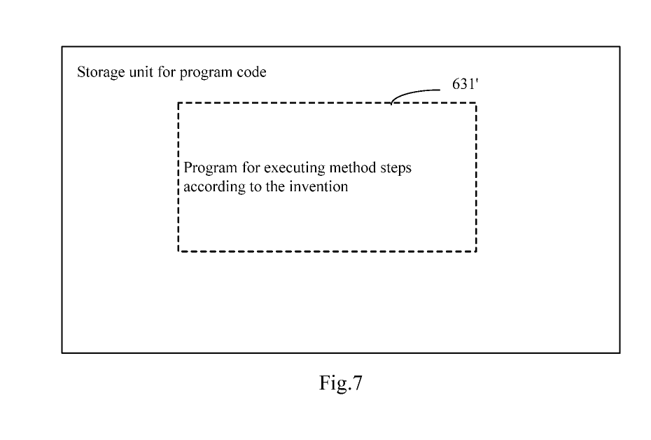

For example, FIG. 6 shows a server which may carry out a method for setting a virtual keyboard according to the disclosure, e.g., an application server. The server traditionally comprises a processor 610 and a computer program product or a computer readable medium in the form of a memory 620. The memory 620 may be an electronic memory such as a flash memory, an EEPROM (electrically erasable programmable read-only memory), an EPROM, a hard disk or a ROM. The memory 620 has a memory space 630 for a program code 631 for carrying out any method steps in the methods as described above. For example, the memory space 630 for a program code may comprise individual program codes 631 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 7. The storage unit may have a memory segment, a memory space, etc. arranged similarly to the memory 620 in the server of FIG. 6. The program code may for example be compressed in an appropriate form. In general, the storage unit comprises a computer readable code 631′, i.e., a code which may be read by e.g., a processor such as 610, and when run by a server, the codes cause the server to carry out individual steps in the methods described above.

“An embodiment”, “the embodiment” or “one or more embodiments” mentioned herein implies that a particular feature, structure or characteristic described in connection with an embodiment is included in at least one embodiment of the disclosure. In addition, it is to be noted that, examples of a phrase “in an embodiment” herein do not necessarily all refer to one and the same embodiment.

In the specification provided herein, a plenty of particular details are described. However, it can be appreciated that an embodiment of the disclosure may be practiced without these particular details. In some embodiments, well known methods, structures and technologies are not illustrated in detail so as not to obscure the understanding of the specification.

It is to be noted that the above embodiments illustrate rather than limit the disclosure, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The disclosure may be implemented by means of a hardware comprising several distinct elements and by means of a suitably programmed computer. In a unit claim enumerating several means, several of the means may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the disclosure. Therefore, for those of ordinary skills in the art, many modifications and variations are apparent without departing the scope and spirit of the appended claims. For the scope of the disclosure, the disclosure of the disclosure is illustrative, but not limiting, and the scope of the disclosure is defined by the appended claims.

1. A method for setting a virtual keyboard comprising:
in a current keyboard layout, receiving a character string constituted by selected button key values for password check;
when it is detected that the character string matches a preset password, passing the password check of the character string;
when it is detected that the character string does not match the preset password, resetting the keyboard layout, and changing the button positions corresponding to the button key values in the virtual keyboard; and
in the reset keyboard layout, receiving the character string constituted by selected button key values to continue to perform the password check.

2. The method as claimed in claim 1, wherein the changing the button positions corresponding to the button key values in the virtual keyboard comprises:
reserving the positions of individual buttons in the virtual keyboard and changing the button key values corresponding to the positions of individual buttons.

3. The method as claimed in claim 1, wherein the changing the button positions corresponding to the button key values in the virtual keyboard comprises:
changing the positions of individual buttons in the virtual keyboard, and configuring button key values for the positions of individual buttons.

4. The method as claimed in claim 2, wherein the positions of the individual buttons in the keyboard layout are saved in a list of button areas; individual lists of button areas are saved in a set of lists of button areas; the button key values are saved in a list of button content; and a corresponding relationship between individual button positions and button key values in a selected list of button areas is saved in a list of button layouts.

5. The method as claimed in claim 4, wherein the reserving the positions of individual buttons in the virtual keyboard and changing the button key values corresponding to the positions of individual buttons comprises:
emptying the corresponding relationship between the positions of the individual buttons and the button key values in a selected list of button areas within the list of keyboard layouts;
obtaining a button key value randomly from a list of button content for a button area in the selected list of button areas within the list of keyboard layouts; and
establishing a corresponding relationship between the button areas and the button key values, and saving it into the list of keyboard layout.

6. The method as claimed in claim 14, wherein the changing the positions of individual buttons in the virtual keyboard, and configuring button key values for the positions of individual buttons comprises:
emptying the list of keyboard layout;
selecting a list of button areas from a set of lists of button areas, which is different from the list of button areas selected by the current keyboard layout;
obtaining a button position randomly from the selected list of button areas;
obtaining a button key value randomly from a list of button content; and
establishing a corresponding relationship between the button positions and the button key values and saving it into the list of keyboard layout.

7. The method as claimed in claim 4, wherein in the list of button content there is further comprised the display content of the buttons, and there is a one-to-one correspondence between the display content of the buttons and the button key values

8. The method as claimed in claim 1, wherein after it is detected that the character string does not match the preset password, there is further comprised:
detecting whether the number of input times has reached a threshold, and if yes, resetting the keyboard layout, or else receiving a character string again; wherein the number of input times is a number of times for which the inputted character string in the current keyboard layout does not match the preset password.

9. An apparatus for setting a virtual keyboard comprising at least one processor to execute a plurality of modules comprising:
a reception module configured to, in a current keyboard layout, receive a character string constituted by selected button key values for password check;
a verification passing module configured to, when it is detected that the character string matches a preset password, pass the password check of the character string;
a layout changing module configured to, when it is detected that the character string does not match the preset password, reset the keyboard layout, and change the button positions corresponding to the button key values in the virtual keyboard; and
triggering the reception module for, in the reset keyboard layout, receiving the character string constituted by selected button key values to continue to perform the password check.

10. The apparatus as claimed in claim 9, wherein the layout changing module comprises:
a first changing sub-module configured to reserve the positions of individual buttons in the virtual keyboard and change the button key values corresponding to the positions of individual buttons.

11. The apparatus as claimed in claim 9, wherein the layout changing module comprises:
a second changing sub-module configured to change the positions of individual buttons in the virtual keyboard, and configure button key values for the positions of individual buttons.

12. (canceled)

13. A non-transitory computer readable medium having instructions stored thereon that, when executed by at least one processor, cause the at least one processor to perform operations for setting a virtual keyboard, which comprises the steps of:
in a current keyboard layout, receiving a character string constituted by selected button key values for password check;
when it is detected that the character string matches a preset password, passing the password check of the character string;
when it is detected that the character string does not match the preset password, resetting the keyboard layout, and changing the button positions corresponding to the button key values in the virtual keyboard; and
in the reset keyboard layout, receiving the character string constituted by selected button key values to continue to perform the password check.

14. The method as claimed in claim 3, wherein the positions of the individual buttons in the keyboard layout are saved in a list of button areas; individual lists of button areas are saved in a set of lists of button areas; the button key values are saved in a list of button content; and a corresponding relationship between individual button positions and button key values in a selected list of button areas is saved in a list of button layouts.
